(19) United States
(12) Patent Application Publication
(10) Pub. No.: US 2008/0062424 A1
(43) Pub. Date: Mar. 13, 2008

(54) Compact Ringlight

(76) Inventors: Mark Richard Shires, Glendale, WI (US); Howard Stern, Greenlawn, NY (US)

Correspondence Address: Mark Shires c/o International Product Technology, 3100 S. 166th St., New Berlin, WI, 53151, US

(21) Appl. No.: 11/899,237

(22) Filed: Sep. 5, 2007

Related U.S. Application Data
(60) Provisional application No. 60/842,769, filed on Sep. 7, 2006.

(51) Int. Cl. G01N 21/47; F21V 7/00

(52) U.S. Cl. 356/446; 362/296

(57) ABSTRACT

A compact ringlight that emulates the performance of a much larger ringlight is disclosed. The invention utilizes a ringlight source and a conical or cylindrical reflector such that light first crosses the optical axis and then is reflected back towards the inspection area. This light is particularly useful for inspecting electronic semiconductor devices.

### CROSS REFERENCE TO RELATED APPLICATIONS

This application claims the benefit of provisional patent application Ser. No. 60/842,769 filed Sep. 7, 2006 by the present inventor.

### FEDERALLY SPONSORED RESEARCH

Not Applicable.

### SEQUENCE LISTING OR PROGRAM

Not Applicable.

### BACKGROUND

1. Field of the Invention

The present invention relates generally to light sources and more specifically it relates to ringlights commonly used for machine vision inspection of electronic semiconductor devices.

2. Prior Art

It can be appreciated that ringlights have been in use for years. Ringlights are commonly used in machine vision applications where it is often desired to have a light source, emanating from a circle, surround the inspection area. Ringlights are often used as darkfield illuminators to illuminate vertical features such as scratches, chip-outs, debris, pin 1 dimples and laser markings in semiconductor packages. They are also often used to inspect BGA (Ball Grid Array) semiconductor devices (or bumped devices) for defects in solder balls, or to measure solder ball locations.

Previous ringlights for semiconductor inspection typically employ a 3″ to 5″ diameter circle of LEDs 1 (see FIG. 1) attached to a circuit board 2, or a fiber optic apparatus that arrange the optical fibers into a similar sized circle. For convenience it is desirable to have a compact ringlight. A small size is particularly desirable when the ringlight is used on a semiconductor processing machine. The overall speed of a machine can often be increased by using a smaller ringlight, because electronic devices often need to be moved with a high-speed pick-n-place that has to travel across the diameter of a ringlight. A smaller ringlight can be traversed by a pick-n-place in a shorter time. Also it is often desirable to inspect multiple devices in one FOV (Field Of View) in order to increase inspection speed. Therefore it is advantageous to have the brightness of light produced by the ringlight to be of even intensity across a large inspection area because machine vision inspection software often uses a threshold value to find features or defects and it is desired that one threshold value would have consistent results throughout the FOV. Additionally it is often desirable to have collimated or nearly collimated light so that the geometry of light incident on the device under inspection is consistent across the entire FOV so that similar features appear similar regardless of their location in the FOV.

Previous small ringlights unevenly illuminate the inspection area, creating brighter areas and darker areas. This often occurs because the size of the inspection area (often 2″×2″) is large compared to the diameter of the ringlight (often only a 4″ inner diameter).

Additionally, the angle of illumination varies across the FOV with typical ringlights. With LED lights, for example, some LEDs are significantly closer to a BGA ball near the corner of the FOV than those in the center of the FOV. Consequently the angle of incidence of light on the inspection area can vary significantly throughout the FOV causing features to look different depending on where they are relative to the ringlight. For example, FIG. 2 illustrates a typical arrangement for inspecting BGA balls. The ringlight consists of LEDs 1 which produce light rays 3 that are incident on the BGA device 4. A camera 7 has a lens 8 to image the BGA balls. Light incident on the center ball 5 has a consistent angle of incidence around the entire ball. Light incident on a non-centered ball 6 has inconsistent angles of incidence. The resulting image (FIG. 3) displays rings of light 9 on the balls 10. However only the center ball's ring is truly centered on the ball. Therefore ring locations do not accurately correspond to actual ball locations. The larger the ringlight is compared to the inspection area, or the more collimated the ringlight, the more centered the rings will be on the balls and thus the more accurately the ball locations can be measured.

While these devices of prior art may be suitable for the particular purpose to which they address, they are not as suitable to maximize accuracy of BGA ball inspection, to minimize the variation of light intensity across the FOV, and to minimize the variation of angle of incidence across the FOV while minimizing the overall size of the unit.

In these respects, the compact ringlight according to the present invention substantially departs from the conventional concepts and designs of the prior art, and in so doing provides an apparatus primarily developed for the purpose of improving the illumination and thus the image produced by a small ringlight.

### SUMMARY OF THE INVENTION

In view of the foregoing disadvantages inherent in the known types of ringlights now present in the prior art, the present invention provides a compact ringlight that emulates a larger ringlight for improved illumination throughout an inspection area.

To attain this, the present invention generally comprises a substantially conical or cylindrically shaped reflective inner surface and a ringlight positioned such that light from the ringlight is directed across and above the inspection area but not incident upon the inspection area until it passes across the optical axis and reflects off of the opposing reflective surface, which then directs it toward the inspection area. The light thus travels a longer distance than a conventional ringlight and thus more nearly collimates the light rays. A baffle is used to block light from illuminating the inspection area prior to reflecting off the opposing reflective surface. Alternatively a lens could be used in place of a baffle. Also, a light source with a well directed or narrow output could be used. Other means are possible to inhibit light from illuminating the inspection area prior to reflecting off of the reflecting surface. Additionally, the substantially conical or cylindrically shaped reflective surface could be octagonal or polygonal and have nearly the same result.

A primary object of the present invention is to provide a small, compact ringlight that emulates the performance of a larger ringlight. A second object is to provide a ringlight that creates more even intensity illumination throughout a larger inspection area. A third object is to provide a ringlight that provides more consistent angles of incidence of light rays throughout a large inspection area. A fourth object is to provide a ringlight that illuminates an inspection area in such a way that the total illumination of any one point in the inspection area is more equally illuminated from all directions. A fifth object is to provide a ringlight which improves machine vision inspection of BGA balls and ball measurements. A Sixth object is to provide a ringlight which improves machine vision inspection of multiple semiconductor devices in the FOV. A seventh object is to provide a ringlight which improves machine vision inspection of scratches, chip-outs, debris, pin 1 dimples, defects and laser markings in semiconductor packages.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is an isometric view of prior art.

FIG. 2 is a side section view of prior art utilizing a standard LED ringlight and camera to inspect a BGA device.

FIG. 3 is a depiction of a camera image of the prior art depicted in FIG. 1.

FIG. 4 is an isometric view of the invention.

FIG. 5 is a cutaway isometric view of the invention.

FIG. 6 is a side section view of the invention and a BGA device.

FIG. 7 is a cutaway isometric view of another embodiment of the invention.

FIG. 8 is a cutaway side view the FIG. 7 embodiment of the invention.

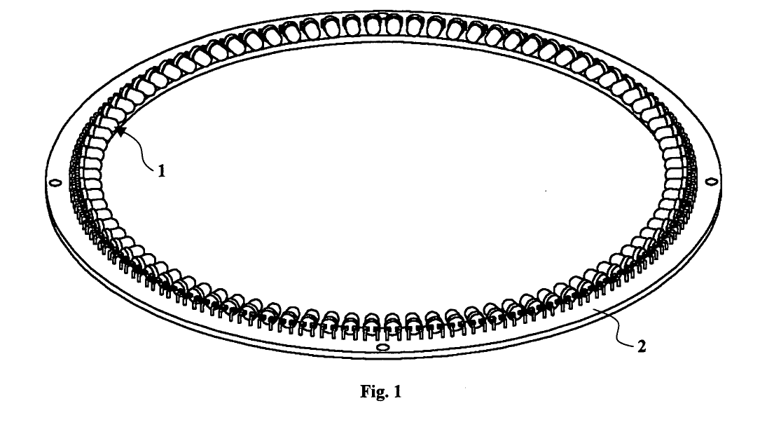

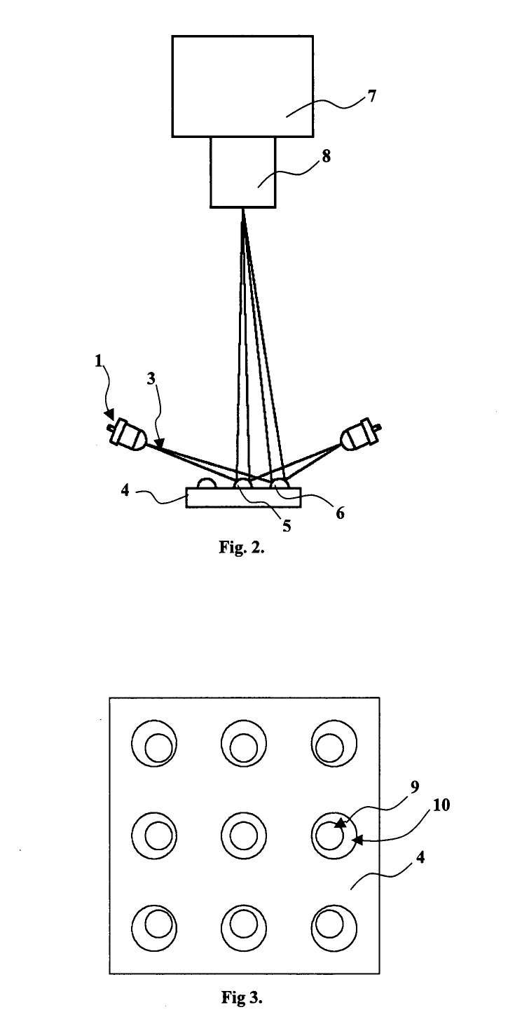

### DETAILED DESCRIPTION OF THE INVENTION

Turning now descriptively to the drawings, in which similar reference characters denote similar elements throughout the several views, the attached figures illustrate the compact ringlight.

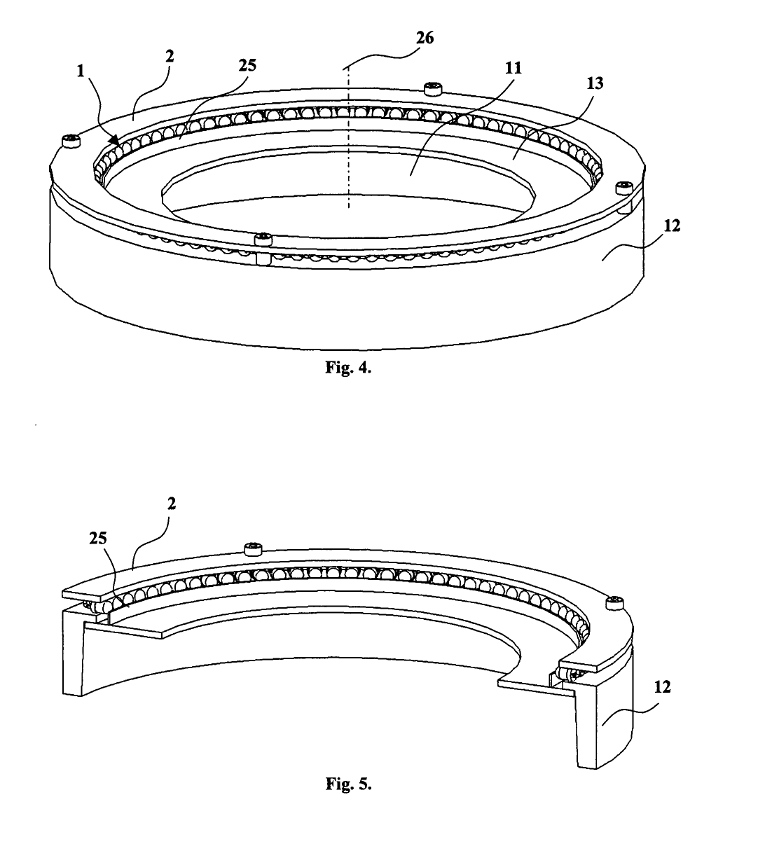

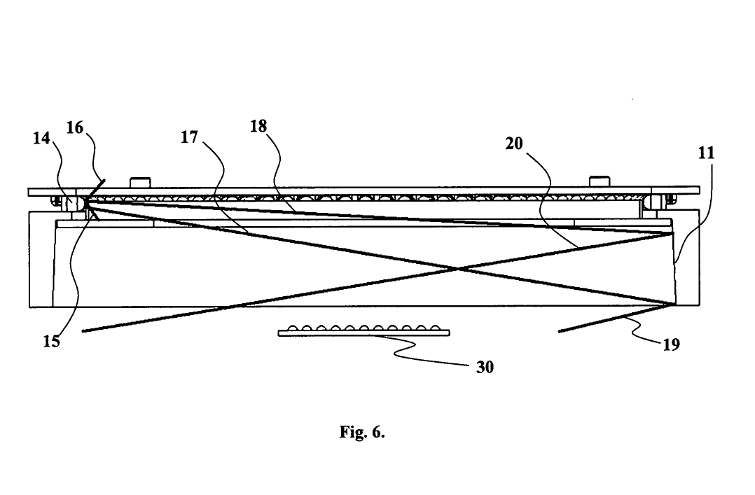

FIG. 4 illustrates a preferred embodiment of the invention. A circular array of LEDs 1 is attached to a circuit board 2. The LEDs are positioned to emit light inward toward the ringlight's axis of symmetry 26 which is also the optical axis of the system. A conical reflective surface 11 is formed by the inner surface of a piece of metal 12. A ring 13 forms an aperture so that light from the LEDs cannot directly illuminate the inspection area but must cross above the inspection area (passing thru the optical axis of the system) and be reflected off of the reflective surface on the opposite side before illuminating the inspection area. A light shaping diffuser 25 (FIG. 5) radially diffuses light.

FIG. 6 is a cut-away side view of the invention positioned above BGA device 30. LED 14 produces a broad diverging beam of light, the outermost rays are depicted as rays 15 and 16. Ray 15, however, is blocked by the ring aperture as are any other rays that could otherwise directly illuminate the inspection area. Ray 16 passes out of the system. Ray 17 just barely clears the ring aperture and passes across the optical axis and above device 4 to be incident on reflective surface 11. The reflected ray 19 is directed back towards the inspection area.

Ray 18 produced by LED 14 passes across the optical axis and above device 4 to be reflected off of reflecting surface 11 as ray 20 which is also directed back towards the inspection area. Any rays produced by LED 14 that are above ray 18 will not be incident on reflecting surface 11 and will not contribute to lighting the inspection area. The result is that only light that has reflected off of reflecting surface 11 will be incident on the device in the inspection area. Therefore the light has traveled approximately 1½ times the diameter of the ringlight before illuminating the device. This long distance means that the vertical angle of incidence of the light across the inspection area is nearly constant (nearly collimated). The long distance also decreases the variation of light intensity across the inspection area.

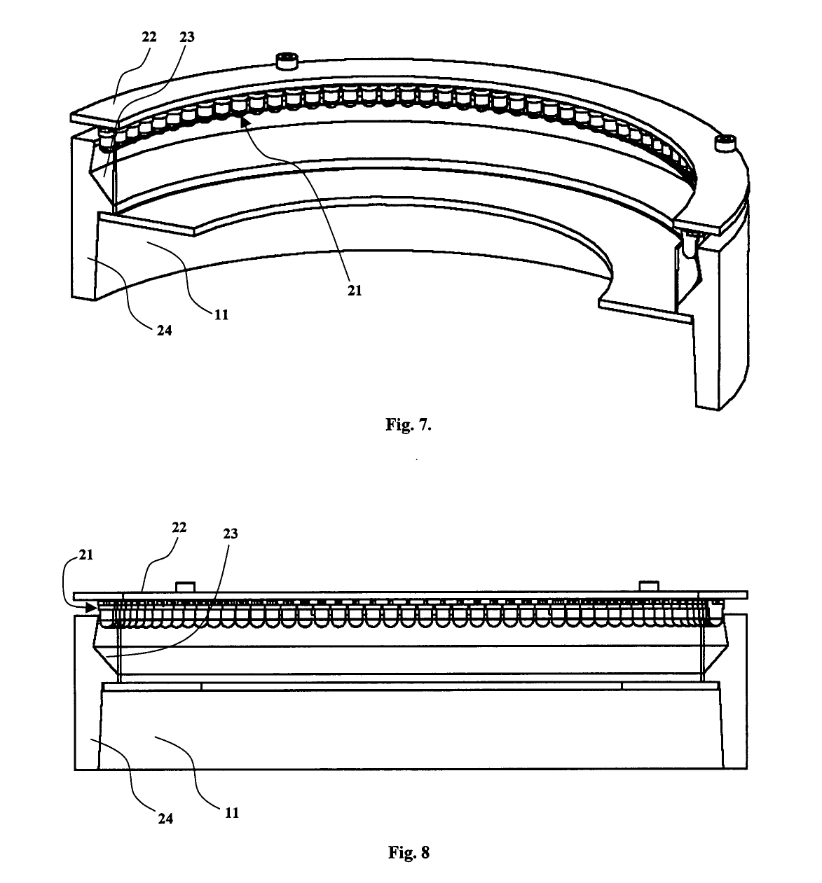

Another preferred embodiment is illustrated in FIG. 7's cutaway isometric view. To avoid bending the LEDs, an additional reflecting surface has been used to create the ringlight. In this case the LEDs 21 are perpendicular to the printed circuit board 22 and aim down to a reflecting surface 23 that is integrated into a piece of metal 24 that also contains the conical reflecting surface 11. Reflecting surface 23 redirects the LED light to travel along the same path as in the previous embodiment. FIG. 8 shows a cutaway side view of this embodiment.

The preferred embodiments use LEDs, 1 however other light sources such as filament or gas bulbs or lasers could be used. A circle of fiber optics could also be used.

The conical reflective surface 11 of the embodiments discussed is formed on metal such as aluminum. Other materials could be used so long as they reflect light sufficiently. Reflective coatings could be used as well. Also the shape need not be conical to embody the idea of the invention. A cylindrical shape could be used. An octagonal or other polygonal shape could also provide the reflective surface required to embody the invention. A paraboloidal shape can collimate the light even further.

The ring aperture 13 is black to absorb light however it could be other colors and the aperture would still function. It is made of metal, however plastic and various other materials would suffice. Alternatively the aperture could be replaced with microlouvers or a lens or other optical baffle so long as light is substantially blocked from illuminating the inspection area directly without first crossing the optical axis and reflecting off of the reflective surface. Alternatively the light source could produce a narrow beam profile where no aperture is required such as with lasers. It should be mentioned that not all desired rays precisely intersect the optical axis, but rather generally pass by the optical axis prior to being incident on the reflective surface.

The light shaping diffuser 25 is a lenticular diffuser consisting of an array of vertically oriented cylindrical lenses to spread light radially (laterally). The diffuser could be some other engineered refractive diffuser such as an array of small lenslets, or standard diffuser material, or holographic diffuser or some other means of diffusion. Spreading light laterally causes the light from all directions to more equally contribute to illuminating each portion of the inspection area. For example, when illuminating BGA balls, balls that are in the corner of the inspection area have circles that are of more even intensity all the way around because of the diffuser. This diffuser also eliminates varied intensity patterns in the inspection area due to the lateral focusing caused by the conical reflector. Alternatively, this diffuser could be eliminated by integrating lateral diffusion into one of the conical reflecting surfaces (23 or 24 of FIG. 7) such as by adding vertical grooves.

What is claimed is:

1. A compact ringlight that emulates the performance of a larger ringlight, said compact ringlight comprising:
a) an annular light source that emits light inward towards its axis of symmetry,
b) a reflector which has an annular inner reflecting surface,
c) positioning said annular light source and said reflector such that their axis of symmetry is substantially coincident and such that light from said light source substantially passes through the axis of symmetry prior to being incident on said reflector which then directs the light towards an inspection area.

2. The compact ringlight of claim 1 which additionally comprises a diffuser to radially diffuse light prior to passing through the axis of symmetry.

3. The compact ringlight of claim 1 which additionally comprises a baffle that blocks light from directly illuminating the inspection area without first reflecting off of the annular reflector.

4. The compact ringlight of claim 1 wherein said annular reflecting surface is conical.

5. The compact ringlight of claim 1 wherein said annular reflecting surface is cylindrical.

6. The compact ringlight of claim 1 wherein said annular reflecting surface is polygonal.

7. The compact ringlight of claim 1 wherein said annular light source additionally comprises an annular reflector used to aim light towards said axis of symmetry.

8. A method for illuminating an object with darkfield lighting, said method comprising:
a) emitting light from a ring and towards the axis of symmetry of said ring,
b) positioning an annular reflective surface such that its axis of symmetry is substantially coincident with the axis of symmetry of said ring, and such that light from said ring is incident on said annular reflective surface after passing through the axis of symmetry of said ring,
c) inhibiting said light from directly striking said object without first reflecting on said annular reflective surface.

9. The method of claim 8 which additionally comprises radially diffusing said light.

10. The method of claim 8 wherein said annular reflective surface is conical in shape.

11. An apparatus for inspecting an electronic semiconductor device with darkfield lighting, said apparatus comprising:
a) a ringlight that emits light towards a center point located on the axis of symmetry of said ringlight,
b) an electronic camera positioned so that its optical axis is substantially coincident with the axis of symmetry of said ringlight,
c) a reflector which has an annular inner reflecting surface,
d) positioning said reflector such that its axis of symmetry is coincident with the axis of symmetry of said ringlight and such that after light from the ringlight passes through said axis it is incident on said reflector which then reflects the light towards said electronic semiconductor device,
e) optical means for preventing light from said ringlight from directly illuminating said electronic semiconductor device without first reflecting off of said reflector.

12. The apparatus of claim 11 which additionally comprises a diffuser to diffuse light radially with respect to said axis of symmetry.

13. The apparatus of claim 11 which additionally comprises a baffle that blocks light from directly illuminating the inspection area without first reflecting off of the conical reflector.

14. The apparatus of claim 11 which additionally comprises a flat plate with a circular aperture, said plate positioned to block light from directly illuminating the inspection area without first reflecting off of the conical reflector.

15. The apparatus of claim 11 wherein said ringlight of claim 1 wherein said annular inner reflecting surface is substantially paraboloidal.
